(19) United States
(12) Patent Application Publication
(10) Pub. No.: US 2025/0276436 A1
(43) Pub. Date: Sep. 4, 2025

(54) MOBILE ACCESSORY RACK

(71) Applicants: Silas Clark, Ottawa, KS (US); Holly Clark, Ottawa, KS (US)

(72) Inventors: Silas Clark, Ottawa, KS (US); Holly Clark, Ottawa, KS (US)

(21) Appl. No.: 18/594,499

(22) Filed: Mar. 4, 2024

(51) Int. Cl. B25H 3/04; E02F 9/00

(52) U.S. Cl. CPC B25H 3/04; E02F 9/00

(57) ABSTRACT

A mobile accessory rack for holding accessories includes a framework having a pair of lower side rails that each defines open ends and a first channel extending therebetween. The framework includes a pair of support rails extending between said ends of said pair of lower side rails, each support rail having open ends and that define a second channel extending therebetween. The lower side rails and support rails are hollow and configured to receive respective prongs of a forklift for movement thereof. Further, the framework includes a pair of guide brackets extending upwardly from said pair of lower side rails, each guide bracket defining a primary slot having an open end and extending inwardly at an angle for frictionally receiving a skid steer bucket therein. The framework may also include a plurality of pockets each being configured to hold a skid steer accessory in an upright configuration.

### BACKGROUND OF THE INVENTION

This invention relates generally to storage containers and, more particularly, to a storage rack for mounting skid steer accessories that is portable and mobile using the skid steer itself.

In the world of construction and landscaping, skid steers are versatile workhorses and capable of performing a myriad of tasks. Skid steers are known for their adaptability, and the use of various attachments allows them to tackle a wide range of tasks. However, the challenge lies in efficiently managing these accessories on the job site. One key aspect that enhances their efficiency is the utilization of accessory racks specifically designed to hold various attachments, such as buckets of different sizes, augurs, and other essential tools. An accessory rack designed for holding buckets, augurs, and other tools not only organizes the equipment but also ensures quick accessibility, allowing operators to seamlessly transition between tasks.

More particularly, an accessory rack provides a designated space for each attachment, eliminating the need for scattered tools and potential delays in operations. This organized setup allows operators to focus on the job at hand without wasting time searching for the right attachment. Further, time is of the essence on a job site, and the ability to swiftly switch between attachments is a game-changer. A movable accessory rack enables skid steer operators to easily engage with the rack, secure the required attachment, and proceed with the task, all within a matter of minutes. Traditional methods of manually changing attachments can lead to downtime, impacting project timelines. The convenience of a movable accessory rack significantly reduces downtime by streamlining the attachment change process, ultimately boosting overall productivity.

Still further, an accessory rack should be easily movable, allowing it to be transported and positioned by the skid steer itself. This mobility enhances flexibility on the job site, enabling operators to position the accessories exactly where they are needed.

Therefore, it would be desirable to have a customized storage apparatus for storing and making available a myriad of tools and accessories commonly used by a skid steer operator relative to a construction or landscaping job site. Further, it would be desirable to have a customized storage apparatus that is mobile and easily movable by the skid steer itself. In addition, it would be desirable to have a customized storage apparatus from which skid steer accessories can be mounted to a skid steer without significant manual or human effort.

### SUMMARY OF THE INVENTION

A mobile accessory rack for holding accessories according to the present invention includes a framework having a pair of lower side rails that are laterally displaced from and parallel to one another. Each lower side rail defines opposed ends that are open and define a first channel extending therebetween. The framework includes a pair of support rails extending between said ends of said pair of lower side rails, respectively. Each support rail has opposed ends that are open and define a second channel extending therebetween. Importantly, the lower side rails and support rails are hollow and configured to receive respective prongs of a forklift for selective movement thereof. Still further, the framework includes a pair of guide brackets extending upwardly from said pair of lower side rails, respectively, and being parallel to one another, each guide bracket defining a primary slot having an open end and extending inwardly at an angle. Each primary slot is configured to receive a skid steer bucket.

In another aspect, the mobile accessory rack may include a plurality of “pockets” each being configured to receive a portion of his skid steer accessory so as to maintain the accessory in an upstanding and stable configuration so that the accessory can be easily uploaded or mounted to the skid steer itself without any substantial human effort. In some embodiments, the mobile accessory rack may include a handle or flange under which a bucket of a medium or heavy lifting device is may lift the entire framework. The mobile accessory rack 10 may also include a shelf or a top wall atop which further accessories may be mounted.

Therefore, a general object of this invention is to provide a mobile accessory rack configured to receive and store at least one skid steer bucket and which may be lifted and moved via at least one skid steer bucket when it is coupled to a skid steer vehicle and actuated.

Another object of this invention is to provide a mobile accessory rack, as aforesaid, having a framework configured to receive prongs of a forklift by which the framework may be lifted and moved, such as on a worksite.

Still another object of this invention is to provide a mobile accessory rack, as aforesaid, having a pair of brackets each defining a slot configured to receive a skid steer bucket in a position where it may be deposited by or connected to a skid steer with minimal human action.

Yet another object of this invention is to provide a mobile accessory rack, as aforesaid, in which the bracket slots may be configured at an upward or downward angle and a particular edge thereof may be serrated so as to enhance a frictional coupling with an inserted bucket.

Other objects and advantages of the present invention will become apparent from the following description taken in connection with the accompanying drawings, wherein is set forth by way of illustration and example, embodiments of this invention.

### BRIEF DESCRIPTION OF THE DRAWINGS

FIG. 1a is a perspective view of a skid steer engaged with, lifting, and moving a mobile accessory rack according to a preferred embodiment of the present invention;

FIG. 1b is a perspective view of the mobile accessory rack 10 as in FIG. 1a, illustrated having deposited the mobile accessory rack onto a ground surface;

FIG. 1c is an isolated view on an enlarged scale taken from FIG. 1b;

FIG. 1d is an isolated view on an enlarged scale taken from FIG. 1b;

FIG. 1e is an isolated view on an enlarged scale taken from FIG. 1b;

FIG. 2a is a side view of the mobile accessory rack as in FIG. 1a, illustrated in one configuration;

FIG. 2b is a side view of the mobile accessory rack as in FIG. 1a, illustrated in another configuration;

FIG. 2c is a side view of the mobile accessory rack as in FIG. 1a, illustrated in still another configuration;

FIG. 3a is a rear view of the mobile accessory rack as in FIG. 1b;

FIG. 3b is an isolated view on an enlarged scale taken from FIG. 3a;

FIG. 3c is a side view of the mobile accessory rack as in FIG. 3a;

FIG. 3d is an isolated view on an enlarged scale taken from FIG. 3c;

FIG. 3e is an isolated view on an enlarged scale taken from FIG. 3c;

FIG. 3f is another side view of the mobile accessory rack as in FIG. 3c, illustrating that a slot may have a downwardly sloping angle;

FIG. 3g is another side view of the mobile accessory rack as in FIG. 3c, illustrating that a slot may have an upwardly sloping angle

FIG. 4a is a perspective view of a mobile accessory rack according to the present invention having a truncated construction;

FIG. 4b is a perspective view from a reverse angle of the mobile accessory rack as in FIG. 4a;

FIG. 5a is a perspective view of a mobile accessory rack according to another embodiment of the present invention;

FIG. 5b is a perspective view from a reverse angle of the mobile accessory rack as in FIG. 5a;

FIG. 6a is a perspective view of a mobile accessory rack according to another embodiment of the present invention;

FIG. 6b is a side view of the mobile accessory rack as in FIG. 6a;

FIG. 7a is a side view of the mobile accessory rack as in FIG. 6a, illustrated with a digging machine preparing to lift the accessory rack;

FIG. 7b is another side view of the mobile accessory rack as in FIG. 7a, illustrated showing the digging machine engaged with the mobile accessory rack; and

FIG. 7c is another side view of the mobile accessory rack as in FIG. 7a illustrated showing that the mobile accessory rack has been moved into a position engaged with the digging machine.

### DESCRIPTION OF THE PREFERRED EMBODIMENT

A mobile accessory rack according to a preferred embodiment of the present invention will now be described with reference to the accompanying drawings. The mobile accessory rack 10 is intended to be moved by engagement with a skid steer 100 or other heavy equipment vehicle. The mobile accessory rack 10 may include a base portion 15 having both side rails and support rails arranged perpendicularly relative to one another, each being hollow and configured to receive prongs of a forklift by which the mobile accessory rack 10 may be lifted and moved as will be described in more detail later. Further, the mobile accessory rack 10 may also include a pair of guide brackets 20 each defining a slot 24 configured to receive a portion of a skid steer bucket 102. In addition, the mobile accessory rack 10 may include a plurality of pockets 30 each being configured to secure an accessory such as an auger 104 in an upright position where it may be conveniently operatively coupled to a skid steer 100 with minimal human effort. Other structures intended to securely hold skid steer accessories for storage or transport will be described below in more detail.

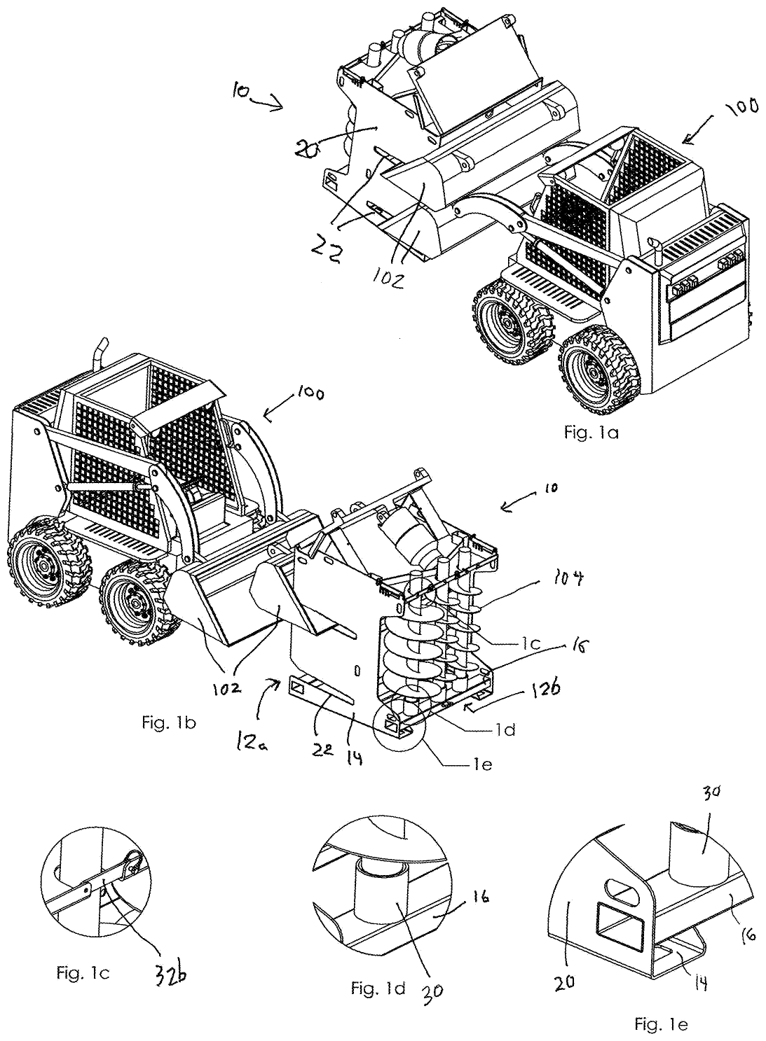

More particularly, the mobile accessory rack 10 is a framework 12 that includes structures that enable the entire mobile accessory rack 10 to be lifted and moved around a jobsite in multiple ways. For instance, the framework 12 includes a pair of lower side rails 14 that may be accessed by respective prongs of a forklift approaching from either the front 12a or the rear 12b of the framework 12, respectively. Alternatively, the framework 12 may include a pair of support rails 16 perpendicular to the pair of lower side rails 14 and each of which may be accessed by respective prongs of a forklift approaching from a left or right side of the framework, respectively. In addition, a skid steer 100 may engage a bucket 102 that is being stored on the framework 12 such that the entire framework 12 is lifted when the bucket is actuated by the skid steer 110 to lift (FIG. 1a).

The means for lifting and moving the framework 12 will now be described with even greater detail. The framework 12 may include a pair of lower side rails 14 displaced from one another in a parallel configuration, each lower side rail 14 having an elongate configuration extending completely between front and rear ends 12a, 12b of the framework 12. As context, it is the pair of lower side rails 14 that rest atop a ground surface when the framework 12 is not being lifted and which constitute the base portion 15 upon which the remaining structures of the framework 12 are supported. In an embodiment, each lower side rail 14 may have an elongate, linear, rectangular, and hollow configuration that defines a first channel that is complementary to a configuration of a pair of prongs of a forklift. In other words, the prongs of a forklift may be inserted into open ends of the first channel defined by the pair of lower side rails 14, respectively, and the entire framework 12 may then be lifted when the forklift is actuated, such as via operation of an electric motor.

An electric forklift motor is a device that converts electro-chemical energy provided by an industrial battery into mechanical energy. An electric forklift motor must provide motion for the unit—forward, reverse, up and down—as well as power other items such as hydraulic pumps and electrical components. Forklifts, also called lift trucks, are classified by size and fuel. Classes 1, 2, and 3 trucks are electric, powered primarily by lead-acid batteries, which can act as a counterweight. Class 4 and 5 lift trucks use internal combustion engines, fueled most often by propane, but also natural gas, gasoline, and diesel.

Further, the framework 12 may include a pair of support rails 16 displaced from one another in a parallel configuration, each support rail 16 having an elongate configuration extending completely between opposed sides 13 of the framework 12. In an embodiment, each support rail 16 may have an elongate, linear, rectangular, and hollow configuration that defines a second channel that is complementary to a configuration of a pair of prongs of a forklift. In other words, the prongs of a forklift may be inserted into opposed open ends of the second channel defined by the pair of support rails 16, respectively, and the entire framework 12 may then be lifted when the forklift is actuated, such as via operation of an electric motor. Importantly, the opposed ends of the pair of support rails 16 are positioned immediately atop opposed ends of the pair of lower end rails 14 (FIG. 1e). Accordingly, access to appropriate channels for lifting via forklift are immediately adjacent one another and are perpendicular to one another, respectively.

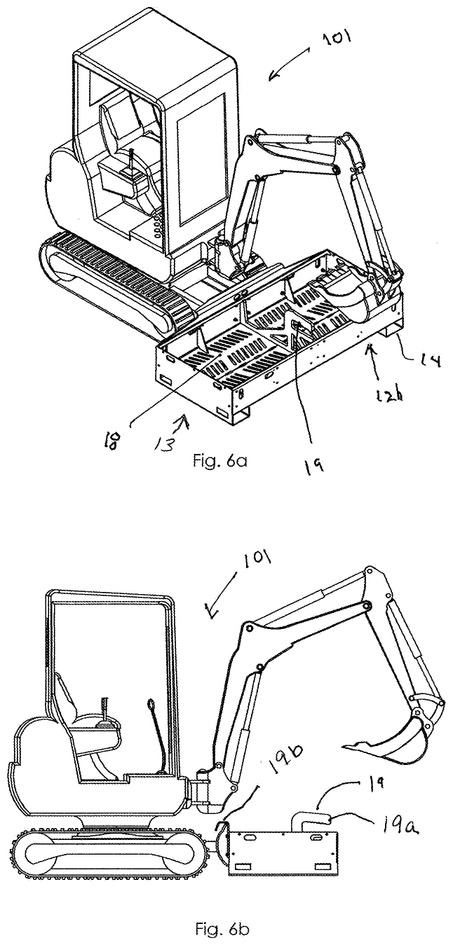

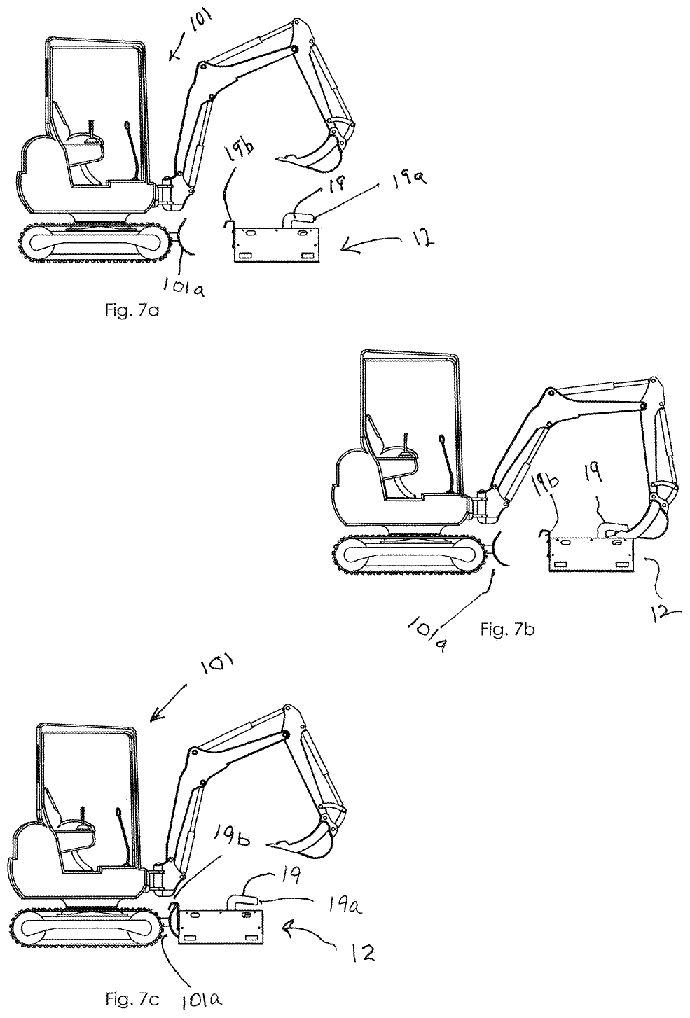

In an embodiment, the framework may include a pair of guide brackets 20 each extending upwardly from the pair of lower side rails 14, respectively. Each guide bracket 20 is essentially an upstanding side panel and the guide brackets 20 are preferably parallel to one another and spaced apart such that the framework 12 defines an interior area suitable for storing skid steer accessories. The simplest embodiment of the framework 12 is shown in FIGS. 6a to 7c. In this embodiment, the framework 12 may include a bottom floor 18 upon which tools, accessories, work materials, and the like may be secured. In another aspect, the framework 12 may include a handle 19 having an L-shaped configuration and that includes a free end 19a that enables the handle 19 to be engaged by a bucket of the skid steer 100 or other heavy equipment 101. Stated another way, the handle 19 provides another means for lifting and moving the mobile accessory rack 10. In an embodiment, the framework may also include a mounting flange 19b for selectively engaging a blade or other frame member 101a of the heavy equipment 101.

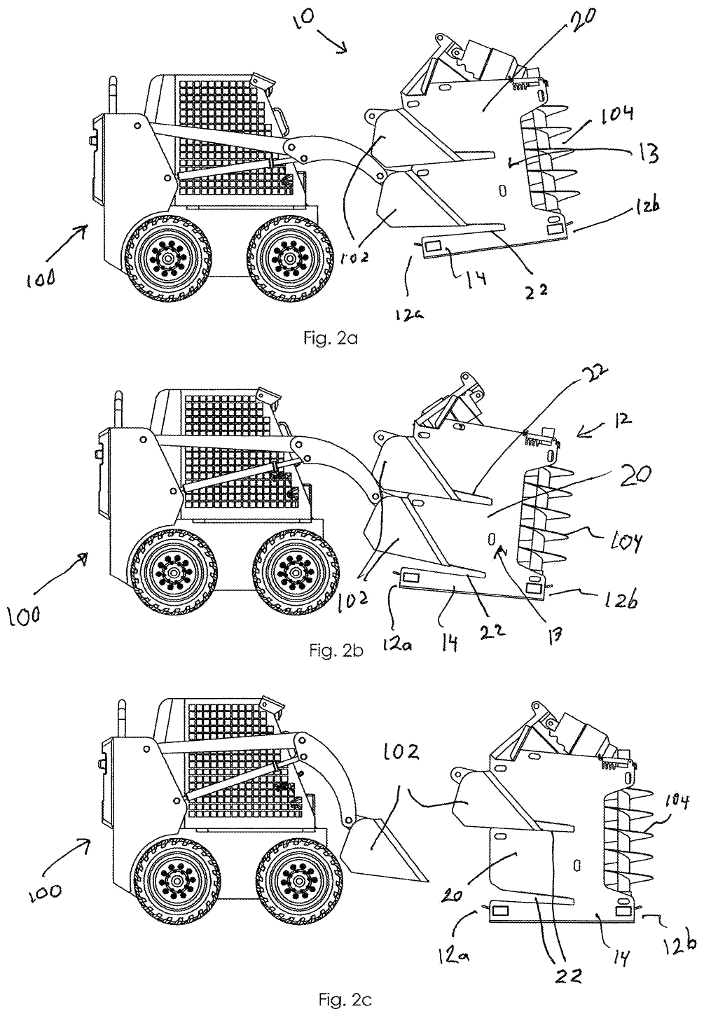

In an embodiment, each guide bracket 20 defines an inwardly extending slot 22. More particularly, each guide bracket 20 may include a pair of slots 22 in parallel and displaced vertically from one another, each slot 22 being open along rear edges 21 of the guide brackets 20, respectively. The pair of slots 22 may also be referred to as a primary slot (lower) and an auxiliary slot (upper) suitable for receiving two buckets 102, respectively. It is understood that each slot 22 has a configuration that is complementary or conducive to receiving a bucket 102 (i.e., a skid steer bucket). More particularly, each slot 22 may include a lower edge 22a and an upper edge 22b that is displaced from the lower edge 22a. Even more particularly, the upper edge 22b is decreasingly displaced from the lower edge 22a as the slot extends inwardly away from the rear edge 21 until upper and lower edges essentially converge at a closed end (FIG. 2c).

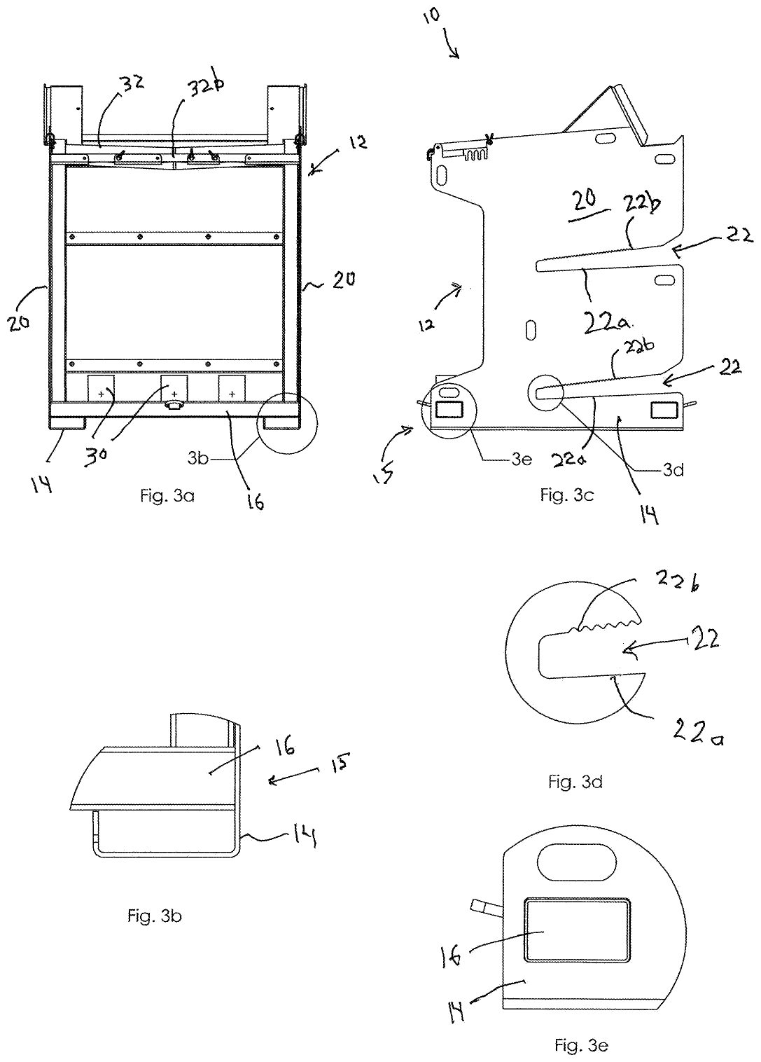

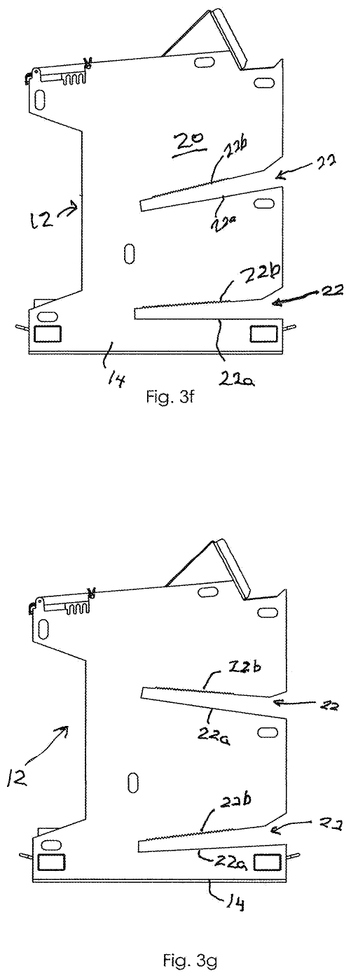

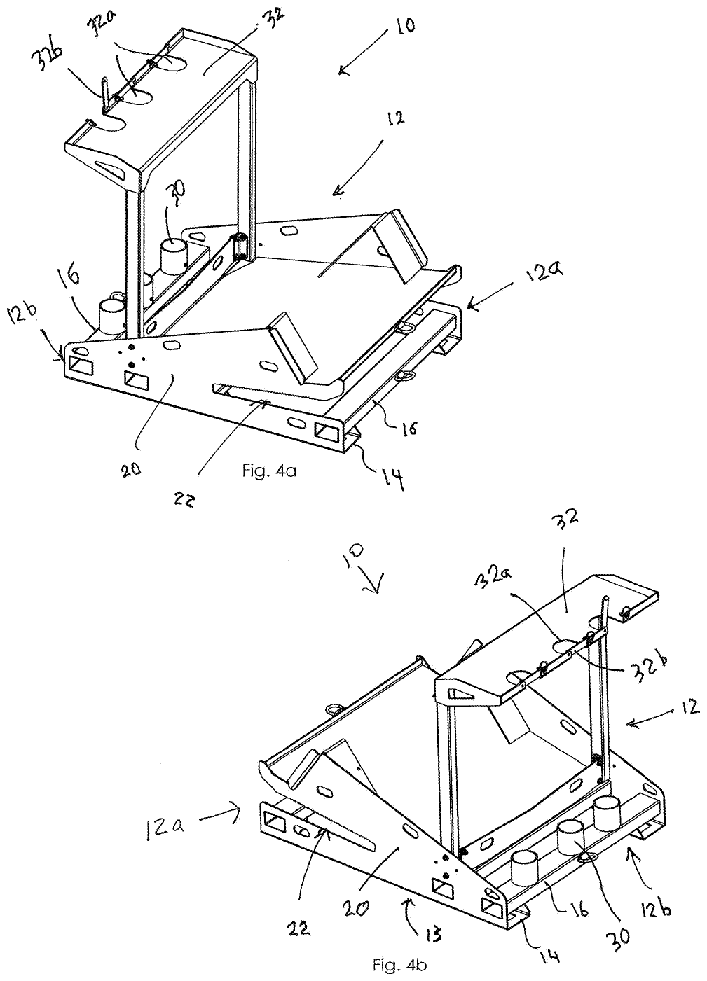

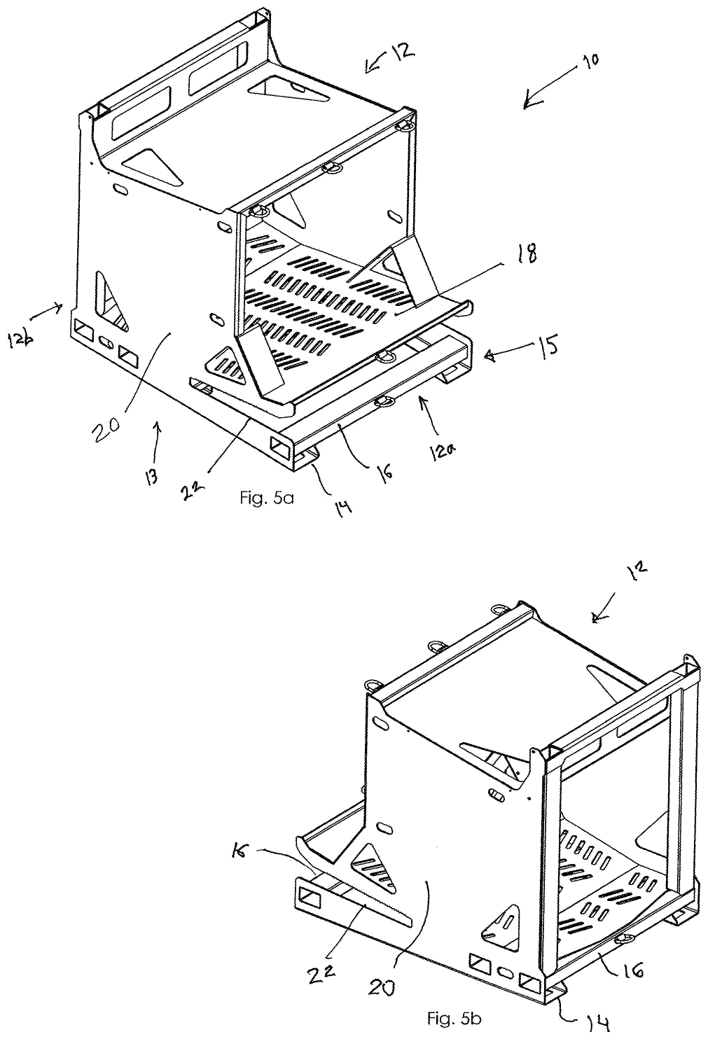

In an embodiment, the upper edge 22b may have a serrated configuration (FIG. 3d) so as to impart enhanced friction to a bucket 102 situated within a respective slot 22, especially when the skid steer 100 is actuated to lift said bucket 102 and, therefore, the framework 12. It will be appreciated that a respective slot 22 may be defined as having an upwardly angled configuration (FIG. 3g), a downwardly angled configuration (FIG. 3f), or being parallel with a respective lower side rail 14 (FIG. 3c). The angle of respective slots is important as it may increase or decrease the amount of friction and, therefore, the ease or difficulty by which a bucket 102 may be held in or removed from a respective slot 22.

In another aspect, one of the pair of support rails 16 (preferably, the support rail adjacent a front end 12a of the framework 12 (i.e., the end opposite the bucket slots 22)) includes an upper surface having a flat or planar configuration upon which are mounted a plurality of pockets 30 (FIG. 4b), each pocket being laterally spaced apart from a next adjacent pocket and having a generally hollow or recessed configuration suitable for securing a lower extent of a skid steer accessory such as an auger 104. In some embodiments, the framework may include a top shelf 32 having a planar configuration and extending between upper edges of the pair of guide brackets 20, respectively. Preferably, the top shelf 32 may define a plurality of apertures 32a configured to capture upper portions of a skid steer accessory such as an auger 104. The embodiment described in this paragraph may also include a gate 32b that is movable between open and closed configurations for either securing or releasing the augurs 104.

In use, the mobile accessory rack 10 includes structures for securing skid steer accessories such as buckets, augurs, and the like in positions that can be immediately coupled to a skid steer or other heavy equipment without any significant manual effort. For instance, the mobile accessory rack 10 defines slots configured to receive at least one and preferably two skid steer buckets in a position that the skid steer need only be operated into close proximity with the mobile accessory rack 10 and then make simple connections. Similarly, the mobile accessory rack is configured to store multiple augurs in a vertical configuration that are capable of being operationally coupled to the skid steer when the skid steer is operated into close proximity. Of critical importance, the mobile accessory rack may be lifted and moved by a forklift or by the skid steer itself when it is coupled to one of the stowed buckets.

It is understood that while certain forms of this invention have been illustrated and described, it is not limited thereto except insofar as such limitations are included in the following claims and allowable functional equivalents thereof.

1. A mobile accessory rack for holding accessories, comprising:
a framework including:
a pair of lower side rails that are laterally displaced from and parallel to one another, each lower side rail defining opposed ends that are open and defining a first channel extending therebetween;
a pair of support rails extending between said ends of said pair of lower side rails, respectively, each support rail having opposed ends that are open and defining a second channel extending therebetween;
a pair of guide brackets extending upwardly from said pair of lower side rails, respectively, and being parallel to one another, each guide bracket defining a primary slot having an open end and extending inwardly at an angle.

2. The mobile accessory rack as in claim 1, wherein:
said opposed ends of said pair of support rails are situated atop said opposed ends of said pair of lower side rails, respectively;
each support rail has a linear configuration; and
each lower side rail has a linear configuration.

3. The mobile accessory rack as in claim 2, wherein each said first channel and each said second channel are configured to receive a forklift prong by which said framework is selectively lifted.

4. The mobile accessory rack as in claim 1, wherein each primary slot has a configuration suitable for receiving a loader bucket.

5. The mobile accessory rack as in claim 4, wherein each primary slot includes a lower edge and an upper edge decreasingly displaced from said lower edge.

6. The mobile accessory rack as in claim 5, wherein said upper edge has a serrated configuration.

7. The mobile accessory rack as in claim 1, wherein said primary slot extends inwardly at an upward angle.

8. The mobile accessory rack as in claim 1, wherein said primary slot extends inwardly at a downward angle.

9. The mobile accessory rack as in claim 1, wherein said primary slot extends inwardly at an angle that is parallel to a longitudinal axis defined by said pair of lower side rails.

10. The mobile accessory rack as in claim 1, wherein:
one of said pair of support rails defines an upper surface having a planar surface; and
said framework includes a plurality of accessory pockets mounted atop said upper surface, each accessory pocket defining an interior space and an open top.

11. The mobile accessory rack as in claim 1, wherein said framework includes:
a top shelf having a planar configuration and extending between upper edges of said pair of guide brackets, respectively; and
a handle mounted atop said shelf that has a free end extending rearwardly and a configuration for selectively engaging a lifting device.

12. The mobile accessory rack as in claim 1, wherein said pair of guide brackets define an auxiliary slot displaced upwardly from said primary slot, said auxiliary slot being congruent to the primary slot such that said framework is configured to simultaneously support a pair of buckets of a skid steer.

13. A mobile accessory rack for holding accessories, comprising:
a framework having a base portion in communication with a ground surface;
a pair of guide brackets extending upwardly from said base portion and being parallel to one another, each guide bracket defining a primary slot having an open end in communication with an interior area extending inwardly at an angle;
wherein said interior area of said primary slots together define a configuration for selectively receiving a loader bucket;
wherein each primary slot includes a lower edge and an upper edge decreasingly displaced from said lower edge until said upper edge merges with said lower edge, respectively.

14. The mobile accessory rack as in claim 13, wherein said upper edge is serrated.

15. The mobile accessory rack as in claim 13, wherein said primary slot extends inwardly at an upward angle.

16. The mobile accessory rack as in claim 13, wherein said primary slot extends inwardly at a downward angle.

17. The mobile accessory rack as in claim 13, wherein said primary slot extends inwardly at an angle that defines a horizontal plane.

18. The mobile accessory rack as in claim 13, wherein said pair of guide brackets define an auxiliary slot displaced upwardly from said primary slot, said auxiliary slot being congruent to the primary slot such that said framework is configured to simultaneously support a pair of buckets of a skid steer.

19. The mobile accessory rack as in claim 13, wherein said framework includes:
a pair of lower side rails that are laterally displaced from and parallel to one another, each lower side rail defining opposed ends that are open and defining a first channel extending therebetween; and
a pair of support rails extending between said ends of said pair of lower side rails, respectively, each support rail having opposed ends that are open and defining a second channel extending therebetween.

20. The mobile accessory rack as in claim 19, wherein:
said opposed ends of said pair of support rails are situated atop said opposed ends of said pair of lower side rails, respectively;
each support rail has a linear configuration;
each lower side rail has a linear configuration; and
each said first channel and each said second channel are hollow so as to receive a forklift prong by which said framework is selectively lifted.

21. The mobile accessory rack as in claim 20, wherein:
one of said pair of support rails defines an upper surface having a planar surface; and
said framework includes a plurality of accessory pockets mounted atop said upper surface, each accessory pocket defining an interior space and an open top.

22. The mobile accessory rack as in claim 13, wherein said framework includes:
a top shelf having a planar configuration and extending between upper edges of said pair of guide brackets, respectively; and
a handle mounted atop said shelf that has a free end extending rearwardly and a configuration for selectively engaging a lifting device.

23. The mobile accessory rack as in claim 22, wherein said framework includes a mounting flange extending upwardly from a front end, said mounting flange having an inverted U-shaped configuration for selectively mating with a vehicle.
